(19) United States
(12) Patent Application Publication
(10) Pub. No.: US 2026/0158498 A1
(43) Pub. Date: Jun. 11, 2026

(54) Device and Method for Rounding Graphite Flakes of a Graphite Material

(71) Applicant: NETZSCH Trockenmahltechnik GmbH, Selb (DE)

(72) Inventors: Patrick Schöbel, Frankfurt am Main (DE); Frank Winter, Mühlheim (DE)

(21) Appl. No.: 19/410,388

(22) Filed: Dec. 5, 2025

(30) Foreign Application Priority Data
Dec. 5, 2024 (DE) 10 2024 136 383.5

(51) Int. Cl. B02C 13/18; B02C 13/28; C01B 32/21

(52) U.S. Cl. CPC B02C 13/18; B02C 13/2804; C01B 32/21; C01P 2004/32

(57) ABSTRACT

A device for rounding a graphite-based material having a work space in which the rounding occurs; an insertion device for introducing the graphite-based material into the work space, a number of rounding tools, situated in the work space and configured for rotational surrounding motion, in the form of blades that are positioned on a disk rotating about a rotational axis and in a rotation direction, preferably having at least one guide apparatus and having one separating device to separate fine material and the finest material, having a product outlet and preferably a covering ring, which is positioned above the rounding tools, wherein the disk bears at least 40, preferably at least 45, and especially preferably at least 55 blades per meter of circumference.

### TECHNICAL FIELD

The present invention relates to a device for rounding graphite flakes of a graphite material according to the characteristics of the independent patent claims.

### BACKGROUND

Lithium ion batteries are currently used in a number of electrical devices, such as laptops or hand tools, as well as automobiles. Graphite is typically employed as an anode material in such cases, since graphite, first of all, has good electrical conductivity and thereby proves suitable for outputting current. In addition, the lithium ions can collect easily in the lattice-like structure of graphite during loading of batteries.

One problem in working with graphite as anode material, however, is that in its natural state graphite usually occurs as so-called graphite flakes, whereas spherical graphite is definitely better suited for use as an anode material. The use of spherical graphite results in a higher energy concentration and a greater life expectancy of the accumulator.

For those reasons, flake graphite must be converted into spherical graphite before it can be used as an anode material. As illustrated in FIG. 2A through FIG. 2E, the modification of the morphology of graphite can be accomplished during the conversion of graphite flakes to spherical graphite. In FIGS. 2A and 2B, the graphite is depicted in flake form, with the flakes of FIG. 2A clearly smaller than those in FIG. 2B. FIG. 2C shows an intermediate stage in which the graphite particles are already partly rounded or spherical. Finally, FIGS. 2D and 2E depict spherical graphite.

Conversion of graphite flakes into spherical graphite, or of raw material into corresponding spherical particles, is already familiar in the prior art, where it is referred to as spheroidization.

It is important to emphasize that, in the following comments, all references to graphite material and graphite particles are to be understood as including the corresponding stages in the form of so-called raw coke and the corresponding raw coke particles; this applies as well to other graphite-based particles. This applies as long as it is clearly not stated that the terms “graphite material” and “graphite particles” are to be understood in their original sense, which is preferred. This proviso applies for the entire text which follows, even when it is not expressly repeated.

During the conversion into spherical graphite, the individual graphite particles are not turned into ball-shaped form by milling or grinding processes, but instead the particles are spheroidized through a multiple-step so-called folding process. For this purpose, the individual graphite particles are deliberately set in motion so that they collide with obstacles provided for the purpose. The kinetic energy with which the graphite particles are impacted is adjusted in such a way that the particles are (so far as possible) not destroyed during collision, but merely reshaped. This reshaping is referred to as folding.

Before the flake-shaped graphite particles are spheroidized, they are normally submitted first to a grinding process. This typically occurs by means of a classifier mill. This step in the process serves to reduce the graphite particles and thus to produce graphite flakes that are sufficiently small so that, in the next spheroidization step, spherical graphite of the desired quality or degree of fineness can be obtained.

The actual spheroidization, finally, is accomplished in a so-called sphere sifter. A sphere sifter comprises a work space in which the imported graphite particles are brought into contact with one or more rounding tools that move (typically in rotating manner). Through contact with the rounding tools, the particles are forced to move in the direction of an obstacle, which is also referred to as an impact surface. As the particles collide with the obstacle, the aforementioned folding process takes place.

To obtain the best possible spheroidization, the particles are conducted in the sphere sifter by means of a stream of process gas introduced into the sphere sifter in such a way that the particles are repeatedly accelerated in the direction of the impact surface and are folded there. The particles then circulate during the folding process through the work space of the sphere sifter in such a way that all particles are accelerated multiple times by rounding tools in the direction of the impact surface.

After a certain handling period and correspondingly many folding process, the desired product quality is achieved, and the graphite particles acquire a spherical shape. Since it is not merely deformation that occurs during the spheroidization, but to a minor extent also a splintering, it is essential that the spherical graphite particles are eventually separated from the accumulating particles by an integrated or external sifting device.

One problem with the currently known sphere sifters is that the graphite particles are either not only folded but also, to a great extent, are also unintentionally smashed and thus become waste or—if the process is adjusted to a milder form—forcibly circulated through the work space of the sphere sifter for a relatively long period until all particles have been folded or spheroidized to the extent required.

### SUMMARY

It is the object of the present invention to provide a device in order to conduct a batch process for spheroidization of fine powders with greater efficiency.

According to the invention, this problem is resolved by means of the characteristics of the principal claim based on the device.

Accordingly, the resolution of the problem depends on a device for rounding of graphite material. The device comprises a work space in which the rounding occurs, as well as an insertion device for—primarily—batch-wise introduction of graphite material into the work space. In addition, the device comprises, in the work space, a number of rounding tools in the form of blades or vanes configured for rotating operation.

The blades are disposed on a disk rotating around a rotation axis and in a rotational direction. Preferably, at least one guide apparatus and a separating device for sorting out fine-grained material and the most finely grained material are also provided. Other features of the device are a product outlet and a covering ring, which is disposed above the rounding tools.

The inventive device is characterized in that the disk contains at least 40, preferably at least 45 and most preferably at least 55 blades per meter of circumference, situated at a distance from one another. As a result of this inventive rotary configuration, the material can be held longer in the area of the radial inner edge of the blades and can be struck there. This arrangement is advantageous because the collisions occurring here between the particles and blades are milder and thus ideally suited for folding the particles without notable particle fracturing.

It can be concluded, in principle, that the inventive configuration ensures a more decisively functional improvement over comparable classifier mills, which however are only of similar construction.

With classifier mills, the intended grinding effect is also achieved to a major extent because the particles that are to be milled are gripped by the blades and slung forcefully outward in a radial direction, to strike with great intensity against the sharp-edged, jagged impact surface, which is part of the classifier mill and surrounds the disk with the blades lining its circumference like a belt.

In a sphere sifter of the inventive design, the main action center is different. It is no longer the aforementioned impact surface, because in an inventive sphere sifter that element is preferably far less aggressive. The reason is that it now has only one task, which is to divert upward those particles that emerge, before they are fully broken up, so that they can be recirculated; that is, as they approach in a radially inward direction, they collide with the radially inner end of the blades in order to be folded again.

Thus, the main action center, in an inventive sphere sifter, is the radially inner first one-sixth of the blades, or even better the inward first tenth of the blades and ideally the rounding effect to be encountered there.

In the area just defined, a low relative difference in speed is encountered between the blades and the individual particle. Therefore, the impetus here is no longer sufficient for the fracturing. In addition, because of the rounding on the inside of the blades, after contact there is a speed component moving inward in the direction of the classifier wheel. As a result, the particles are held longer on the inside edge of the blades and, because of the inventive increased number of blades, there occurs an enormously high number of slight contacts that are not conducive to pulverizing action. The contacts can likewise result in a spinning of the particles, which should be advantageous for a folding procedure.

The solution of the aforementioned problem, in addition, also entails a process, which can go into effect at a given time, of rounding the graphite material. Here, the graphite material comes into active contact with at least one rounding tool out of a number of rotatably configured rounding tools that are especially close together along the periphery because approximately 40 to 80 rounding tools or blades are positioned close together along the periphery per meter of peripheral length. In addition, above the rounding tools, a covering ring is positioned ideally, so that the covering ring restricts the available space for a flow of process air containing graphite material and increases the number of contacts between the graphite material and the at least one rounding tool.

With the inventive method and the machine for its use, it is possible in a simple, cost-effective way to produce rounded graphite particles optimized for the production of batteries. In particular, this allows the graphite flakes to be rounded thanks to the action of folding the corners of the graphite flakes and winding them about the core of the graphite flakes.

There are a series of possibilities for configuring the invention so that its effectiveness or usefulness can be improved still further.

Thus, it is especially preferable that the side surfaces, or flanks, of some or all blades (or clubs), in their entirety or at least at their radial outer end comprise a tangent, which forms an angle ALPHA with the radial at its point of tangency.

With such a configuration, the graphite particles are not thrown mostly radially toward the outside but rather intersect diagonally on the inner surface of the housing and the collision or deflecting surface configured there. As a result, there is an improvement in the retransport radially from the blade wheel of thrown graphite particles into the work space. The ALPHA angle remains preferably below 25°. In individual cases, however, angles up to 40° are useful.

In an additional preferred embodiment, the blades take the form of panels, which are curved in an arc shape toward the exterior.

Consequently, the particles are not thrown off essentially radially, but rather with a circling motion component. The particles, as a result, are impacted with an increased spin. This spin likewise leads to an improvement in the retransport radially away from the blade wheel of thrown-off graphite particles into the work space.

Ideally, for the overwhelming majority of blades or all blades, the proportion of the blade length to the blade width should be greater than 5:1 and preferably more than 10:1. This ensures that the blades have a sufficient extension in the radial direction in order to continue accelerating several graphite particles simultaneously. The processing speed of the device is hereby increased. At the same time, a relatively great number of blades can be provided on the disk without allowing the vacant spaces between blades to become too small and thus to interfere too much with the free circulation of the graphite particles through the work space.

The “blade length” is thus the extension of the blades from the end facing the rotation axis of the disk to the end turned away from the rotation axis of the disk.

The “blade width” here is the median extension of a blade from the side facing a first immediately neighboring blade to a second immediately neighboring blade.

The radial length of the blades and/or the distance of immediately neighboring blades and/or the height of the blades in the direction of the rotation axis is advantageously selected in such a way that most of the collision processes between the particles that are to be rounded and the blades occur in the area of the radially inner first one-eighth, or better in the area of the inner first ninth, of the blades.

Within this radially inner area of the blades, for the most part only those blows occur that are too low in intensity to cause the particles to fracture. In classifier mills, therefore, this area is avoided as much as possible, since it is ineffective for milling and in any case is not suitable as the chief collision zone. Accordingly, in classifier mills the blades are situated at a definite distance from one another along the periphery, since only in this manner is it possible for the particles that are to be ground by the classifier mill to penetrate so far into the area between blades that they receive a shattering collision impact, which is delivered by the blades'lateral flank.

This is not the case with the inventive sphere sifter. Here, by means of trials with the parameters cited in the patent claim, the pumping effectiveness of the disk bearing the blades can easily be adjusted, in a manner comparable with the familiar adjustment of the action of a centrifugal pump. With correctly adjusted pumping effect, the vast majority of collisions occur between the particles to be rounded and the blades in a radially one-way intake area of the blades, where the collisions are sufficiently intensive to cause folding but not aggressive enough to fracture a noteworthy amount of the particles.

Preferably, the ratio of the blade length measured in the radial direction and the outer radius of the rotatable disk bearing the blades should be between 0.1 and 0.25 to 1, and most preferably below 0.2 to 1. Maintenance of this ratio ensures that the intensity with which the blades strike the particles is great enough to achieve a folding with good yield without causing particle fracturing to an intolerable extent and thus waste.

Ideally, the height of the blades changes from their radially inner end to their radially outward end, above all in such a way as to produce a height reduction of 10% to 40% of a given blade from the radially inner end to the radially outward end. As a result, the speed and thus also as a rule the volume stream between the blades is held constant. It can be most advantageous here to restrict the pumping effect produced between neighboring blades, in order to prevent the particles from being absorbed too strongly and thus to avoid moving the main collision zone too far in the radially outward direction.

Preferably the diameter of the classifier wheel that is effective for classification is 20% to 50%, or preferably only 20% to 35%, of the outer diameter of the disk on which the blades rotate. This can ensure that the classifier wheel does not come into unnecessary contact with the guard wall (not meant to be subjected to any classifying) composed of particles in the process of the intended spheroidization, and that no collisions instill the particles with an energy not useful for folding and even intolerable.

In another preferred embodiment the impact surface, preferably made up of an area of the cylindrical-shaped inner lining of the housing and against which the particles are thrown by passing through the gap between neighboring blades, have a smooth configuration, rippled but without edges. This serves to avoid the risk that a greater number of particles or particle portions are shattered as a result of striking the edges of the impact surface. That would increase the waste and reduce the efficiency of the apparatus.

This problem is effectively avoided by means of a smooth or rippled collision surface in the region of the inner lining of the housing. It should be mentioned that the impact surface in a sphere sifter of the inventive type, unlike in a classifier mill, does not serve to shrink particles by means of collision but rather has the function of providing a rotation brake for the stream, also revolving, of particles that are to be folded.

The guide apparatus formed from the guide elements is preferably situated flush with the upper edge of the blades. This configuration serves to prevent the graphite particles from streaming past the blades without coming into contact with them. Instead, all particles in every stream passing by are accelerated against a blade by the flow, and folding takes place. To that extent such an embodiment increases the efficiency of the device.

In an additional preferred embodiment, the rounded graphite material is conducted without collision to separating mechanism of the device. This has the effect that the folded particles as well as the splintered-off fine and finest materials optimally flow to the severing mechanism. Accordingly, this embodiment increases the efficiency and effectiveness of the severing mechanism. Alternatively, it can be foreseen that the device, after complete filling, that is after achieving the first switch-off value, is operated for a defined period, which, for example, has first been empirically determined and according to which the rounding of all graphite flakes is securely concluded.

To optimize the process conditions still further, it can be provided that the speed at which the rotating disk and thus the rounding tools are moved can be varied during operation. For example, it can be foreseen that first a low rotation speed is selected, which then, in the course of operation, is increased to a maximum rotation speed.

Alternatively, for certain processes it can also be advantageous to start with an initially high speed and then to reduce it in the course of operation.

Advantageously the device is operated at a maximum rotation count of the rotating disk between 60 meters per second and 120 meters per second (based on the size of the disk).

An inventive sphere sifter functions basically differently from a classifier mill despite their very similar structure at first sight, and this difference is confirmed in other kinds of structural characteristics.

A first difference, significant in its own right, is the fact that a classifier mill remains in continuous operation. Material for grinding is continuously fed into it, and completely ground final product is continuously discharged by sifting.

The inventive sphere sifter, in contrast, operates in bulk, or batchwise, and is configured accordingly. Thus, at the start of the process an entire load of material is inserted for spheroidization in this cycle. Then the material to be spheroidized is processed in the sphere sifter for as long as necessary until—at least, for the most part—it has achieved the desired degree of roundness. During processing, rather than folding, the material is “assorted” by the sifter into automatically miniaturized form by fragmentation. Another difference between an inventive sphere sifter and a classifier mill is that in the latter the end product is extracted by the sifter.

Fundamentally, with an inventive sphere sifter, the rounding must always be guided by the emphasis on the end product and its degree of refinement, because otherwise the particles are reduced during the process. That is something to be avoided by all means. The integrated process of grinding and rounding is the basis for “cascading” operation (i.e., in a series of steps) but is not deliberately employed in batchwise operation.

Experience has shown, moreover, that a deliberate control of intensity in keeping with the aforementioned emphasis has positive effects on product quality. The process can most easily be compared with the folding of a very thin book or, more simply yet, of a single sheet of paper. It requires, on the one hand, the stronger impact in order to fold many layers simultaneously, and, on the other, light impacts in order to smooth the surface and to press any protruding leaves to the ball. In this process, the impacts should, as far as possible or essentially, never occur at an angle of 90° to a tool, since that can lead to breakage rather than folding. It can easily be imagined that an especially high number of impacts will produce an especially smooth sphere. Experiments have also shown that the final folding step in particular requires considerable energy. This again is clearly understandable thanks to the book example mentioned above. Each folding step demands a bit more strength, and the last in particular is very difficult. For truly three-dimensional particles, therefore, a broad distribution of impact below the breakage boundary is ideal. The number of contacts should be maximized in this process.

In summary, then, it can be said that an inventive sphere sifter is configured in such a way that the impacts, to which it subjects the particles that are to be spheroidized, are situated essentially below the intensity of impact that would cause fracturing of the particles. For the most part the sphere sifter here is configured so that the number of impacts to which a particle that is to be rounded is subjected is increased over the length of the batch, compared with a similar classifier mill.

### BRIEF DESCRIPTION OF THE DRAWINGS

The figures are as follows:

FIG. 1 shows an inventive device in a schematic depiction.

FIGS. 2A through 2E show the graphite material before, during, and after the processing within an inventive device.

FIGS. 3A and 3B show a horizontal section through the inventive device according to FIG. 1, illustrating the wheel of blades or a sectional enlargement of the wheel.

FIG. 4 is not assigned.

FIG. 5 Shows a sectional enlargement from FIG. 1.

FIG. 6 shows, as an alternate to the version seen in FIGS. 3A and 3B, a wheel of blades with blades that are all equally thick, in the circumference direction.

FIG. 7 Shows a side view of FIG. 6.

FIG. 8 shows an alternative to the version seen in FIGS. 3A and 3B and FIG. 6 and 7 of a wheel of blades, having blades that are straight in their own right but placed diagonally.

FIG. 9 Shows a side view of FIG. 8.

FIG. 9a shows another preferred embodiment of the wheel of blades.

FIG. 10 shows an alternate version to the one in FIGS. 3A and 3B and FIGS. 6, 7 and FIGS. 8, 9 of a wheel of blades (occasionally also referred to as rounding disk), having blades that are each curved.

FIG. 11 shows a detailed section of FIG. 10.

### DETAILED DESCRIPTION

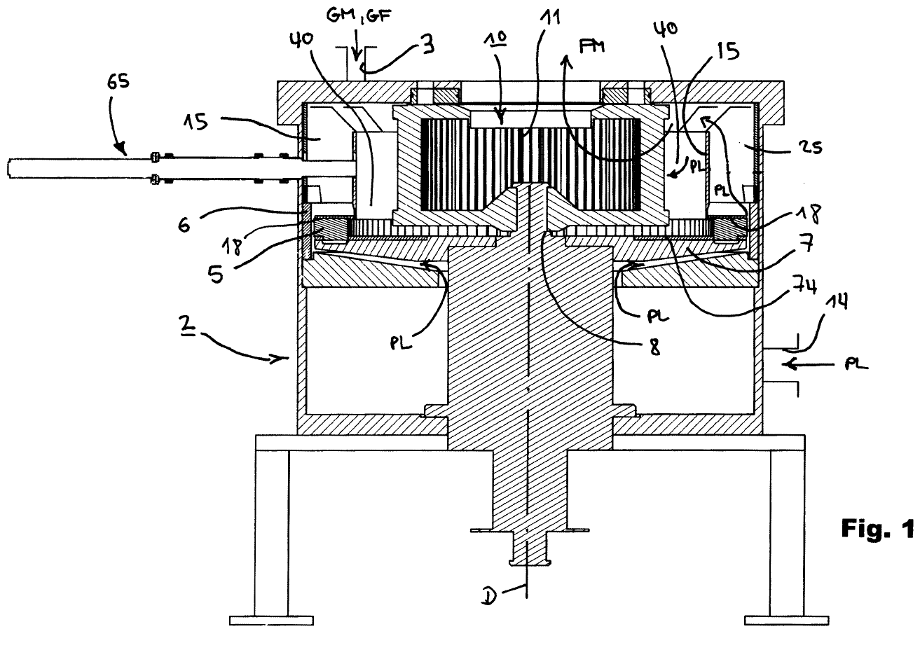

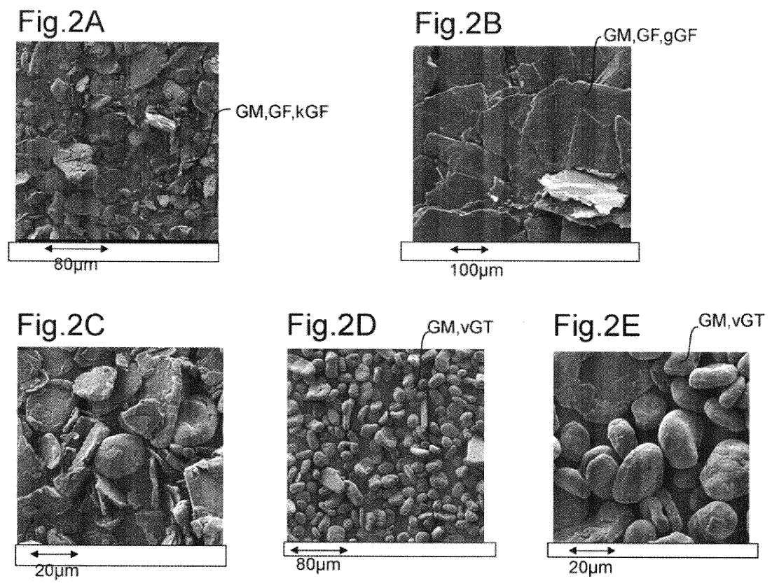

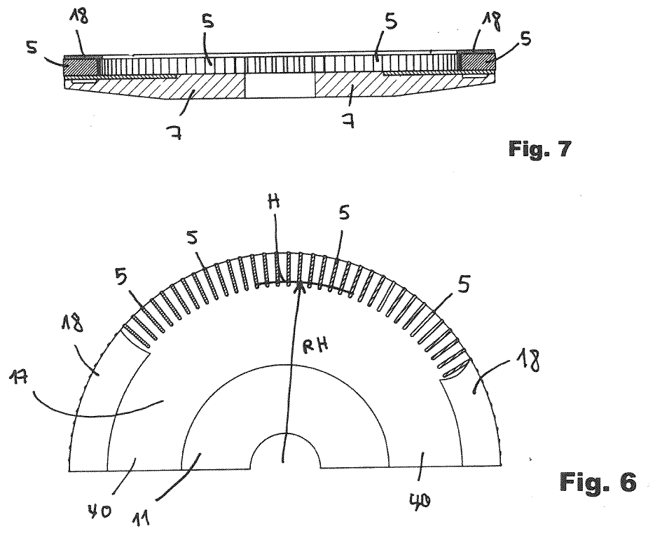

The manner of functioning is explained with reference exclusively, at first, to FIGS. 1 through 5. The embodiments illustrated in FIGS. 6 through 11 will only be discussed thereafter.

Beginning with the fundamental operation of the inventive sphere sifter, the discussion will focus more closely thereafter on individual inventive measures.

FIG. 1 shows an inventive device 1 for rounding graphite flakes GF of a graphite material GM.

The device 1 includes a housing 2 configured nearly as a standing cylinder, on whose upper surface an insertion device 3 is disposed, usually for batchwise introduction of the graphite material GM or raw material. As long as graphite material is introduced, this raw material consists mostly of graphite flakes GF, at least for the most part. In particular, the illustrated embodiment shows the insertion device 3 as a downpipe, although it is also possible for the graphite material GM to be introduced by way of an injector insertion device.

The graphite material GM proceeds downward toward the floor of the work space 40. There it encounters the rounding tool, coming from the radially inner side, which consists of blades 5 which are secured on a disk-shaped carrier or disk 74 that circulates together with the carrier plate or disk 7—a composite that can be designated as a wheel of blades. When the graphite flakes reach the blades at the area of their radially inner end, that is close to the front-end rounding of the blades, then, according to the invention, they are folded. In this process, a major part of the graphite flakes are thrown back into the processing space 40 in the radially inward direction, returning toward the region of the radially inner end of the blade wheel and the blades mounted on it and will be folded again. Graphic particles, which have gone beyond the radially inner area of the blade wheel (generally stated: optionally approximately the innermost ⅕, better the innermost ⅛ of the blade wheel) in the radially outward direction, are moved outward by the blades, which, thanks to their especially close-knit inventive arrangement, act as centrifugal pumps, without further collisions still occurring to any significant extent in the essential area between the blades 5 and the graphite particles, and depart from the blade wheel at its outer circumference.

In so doing, the graphite particles now come into contact with the inner lining surface of the outer wall of the housing 2 of the sphere sifter or with the impact surface 6 situated there, which may often be an independent peripheral component. Generally, and thus not only for this embodiment, it is true that the impact surface (unlike with a classifier mill) is not configured in such a way as to cause collisions that shatter the graphite particles. Instead, the impact surface according to the invention is configured so that, essentially without fragmentation, it supports the tendency of the process air flow PL (see FIG. 1, right-hand side of image) to divert the graphite particles upward through the “chimney” formed by the air guide ring 15 and the air conducting elements 25 and finally to release it back into the processing space 40 in the radially inward direction. In the processing space 40 the graphite particles sink back into the area of its base. In so doing they move outward again under the influence of the centrifugal force. Thereby, as soon as they have reached the base area of the processing space, they are back in contact with the blade wheel or its blades in such a way that they are again folded.

Fragments of graphite particles, though reduced in size unintentionally, experience only minor flight force and thus are drawn into the interior of the classifier wheel 11 (by the process air flow PL entering the separator device 10 or its classifier wheel 11) and are thus carried out by the separator device 10.

The separator device 10 here is positioned above the disk 7 with the rounding tools 5. The classifier wheel 11 is connected with a second drive unit 13 by a second drive shaft 12. In particular, it is foreseen that the first drive shaft 8 and second drive shaft 12 are positioned coaxially.

For the sake of completeness, it should be noted that the process air just mentioned is conducted as follows:

By way of a supply nozzle 14 in the lower area of the device 1, in particular below the rotating disk 7 with the rounding tools 5, process air PL is fed upward from below. It is advanced to the rounding area and through the guide elements 25 to the separator device 10. The process air PL here takes the fine material and/or the most refined material FM, whose flying powers are insufficient to resist the transport effect of the processed air, and feeds this material out of the device 1 by the exhaust nozzle 16.

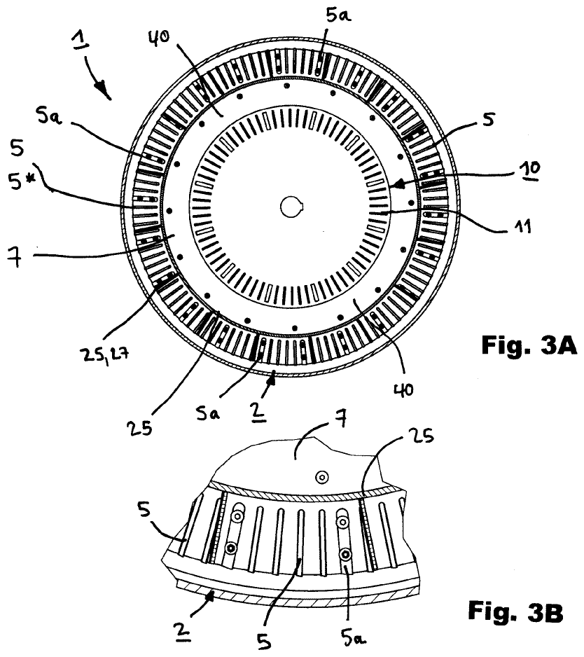

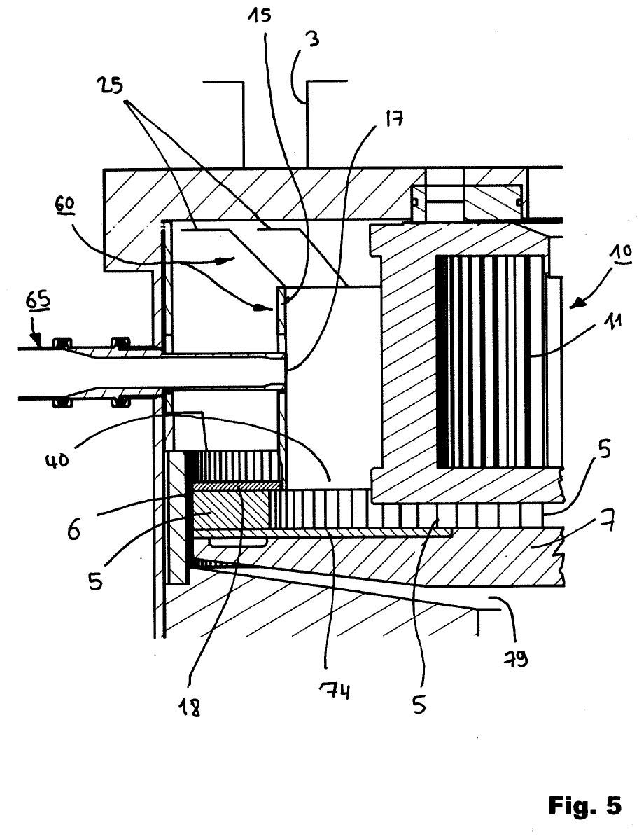

FIG. 3A shows a horizontal longitudinal section through the embodiment that was just explained with particular reference to FIGS. 1 and 5. FIG. 3B shows an enlarged detailed version of the same.

Clearly visible in FIG. 3A is the disk 7, which, together with the blades 5, forms the blade wheel, which follows a circular path in the housing 2.

Also recognizable is the guide element 25 which has been shown in FIG. 1, and FIG. 5 and which, with its arm-like, sharply curved sections 27, is retained immobile in place. It is likewise easy to see how the ring-shaped region between the radially inner end of the blades 5 and the classifier wheel 11 or its axial projection downward forms the processing space 40.

It is obvious at once that the disk 7 is thickly covered with blades. So far it has consistently been assumed that the density of blades in the circumference direction is clearly lower, namely as a rule significantly below 35 blades, and must be kept at 360°. As a result, as later shown to be mistaken, the increased vacant areas between subsequent blades led to fairly intensive collisions between the blades and the graphite particles.

In the framework of the invention, it was recognized that smaller vacant areas between the blades aligned along the periphery can ensure a more efficient but protective folding (with a lower breakage rate and less waste).

Given this background, the following statements can be made here concerning both this embodiment and more broadly:
that the least distance between two immediately neighboring blades 5 is preferably less than the maximum width of a blade in the peripheral direction;
that the majority of blades 5 are particularly thin, in the sense that the maximum blade width in the peripheral direction corresponds to at least 6 times, preferably at least 8 times the maximum blade length in the radial direction;
that along the periphery of the blade wheel, several slender blades 5 arranged immediately alongside one another are followed by one blade 5a having a greater width, which preferably comprises one, better at least two screw-in holes for securing the cover ring 18 covering the tops of the blades 5, 5a, as shown in the covering ring 18 illustrated in FIG. 1;
that the blades 5 are configured in such a way that, along the periphery, at their radially outer end they are spaced farther apart from one another than at their radially inner end;
that the radially inside blades have a rounded, preferably essentially semicircular-shaped end and preferably are also configured in the same manner at their radially outer end;
that the blades each have a constant thickness along their periphery;
that the blades comprise smooth-surfaced lateral flanks so that neighboring blades form a radial channel, which guides the small graphite fragments (which, moving in a laminary stream in a radially outer direction, have left the radially inner area of the blades, predestined for the folding), radially outward-in any case without appreciable additional collisions between the blades;
that the blades are arranged along the periphery so closely together and preferably also circulate at such a speed that the particles predominantly, or essentially all, collide with the rounded, radially inner end of the blades described above on their way onward or into the blade wheel.
the blades must be arranged so close together along the periphery that they can form such a pronounced rounding at their radial end that the particles overwhelmingly, or essentially all, collide on their way onward or into the blade wheel with the rounded radially inner end of the blades described above.

The blades 5 in the embodiment shown in FIGS. 3A and 3B are each aligned parallel to the radials of the disk 7, which runs through the apex of the rounding of a blade 5 facing away from the rotation axis of the disk 7.

FIGS. 6 and 7 show a variant of the blade wheel, which is occupied only by identical blades that, as shown in FIG. 3, are each independently radially oriented. Otherwise, however, this variant corresponds to the embodiment just discussed in relation to FIG. 3, so that (aside from the thicker blades) everything already mentioned is applicable here.

It is still notable that FIG. 6 with the radius RH and the imaginary auxiliary circumference line H, to which it points, visualizes where—with correspondingly closer distancing and optionally corresponding rounding of the blades and optimally with possible corresponding adjustment of the rpms of the blade wheel—the vast majority of the collisions or even essentially all collisions take place, namely in the area of the rounding of the inner end of every blade.

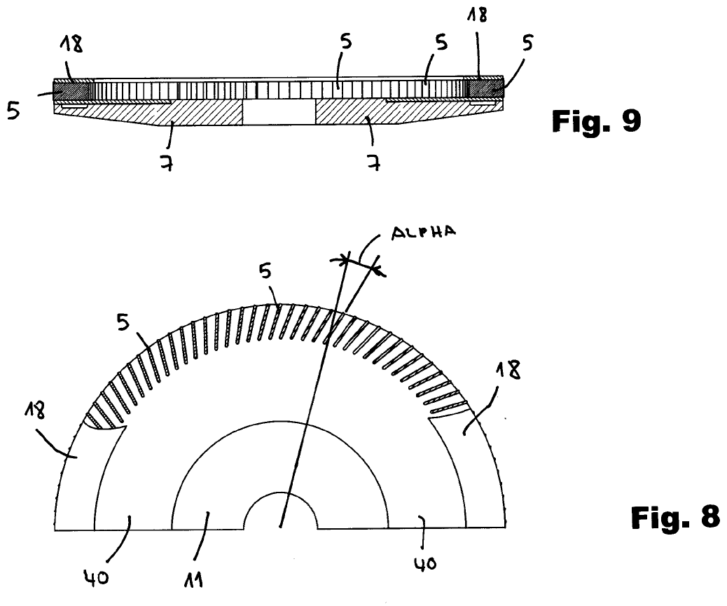

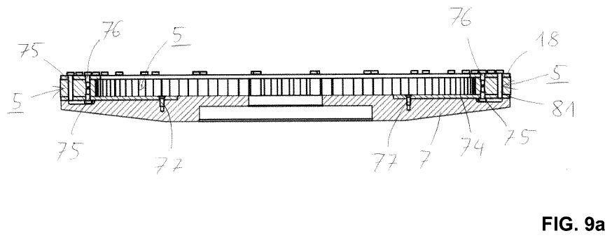

FIGS. 8 and 9 show a third embodiment. In this blade wheel, the blades, still straight in structure, are tilted, preferably at an angle ALPHA of 10° to 25°, or better only 10° to 17.5° to the radial. The shifting occurs in such a way that the radially inner ends of the blades lag behind.

As a result of these measures, the collision effect can be varied and, in some cases, influence can be exerted on the advancing power of the blade wheel, which still causes an effect comparable to a centrifugal pump. One useful aspect is the fact that the particles that have penetrated into the region between the blades are thrown with a collision in the radially outer direction against the impact surface 6, in many cases making it easier for the particles to find their way back into the work space. So far this is all in keeping with the explanation already provided in connection with FIGS. 1 and 5. As can be seen in FIG. 9a, the rounding disk is specially constructed for the present invention. The customary construction is a grinding disk as rotating part, on which the individual blades are then bolted.

The disk 74 is now part of the fastening of the blades.

If one now attempted to employ the present invention with the conventional construction, it would quickly become clear that the rigidity of the blades and bolting connection does not allow the high, thin blade structure foreseen by the invention.

In addition, rotated blades constitute a problem especially because the firmness decreases and the agitating forces increase. In addition, because of the high speeds, blades constitute the main element of wear. Regular replacement of well over 100 blades, each requiring two bolts, would prove expensive.

For this reason, the construction is preferably configured in the manner shown in FIG. 9a. There is one universal disk 7, which constitutes a grinding-disk base, on which various blade rings can be bolted. The pre-mounted rings are fastened by the bolts 77.

The blade rings occupy the disk 74. Two different types of blades are mounted on it. First are the fastening blades 5, which, as can be seen in FIG. 9a, are bolted on, and second are the contained blades, which are inserted in grooves in the disk 74 and the covering ring 18. The entire structure is then firmly bolted together, forming a ring. Thus, when the fastening is insufficient for bolting the desired blade configurations, they can be inserted and it requires only a few fastening blades to be constructed in somewhat stronger form to hold the structure together. This also results in simpler maintenance by the composite ring, which can be replaced as a whole.

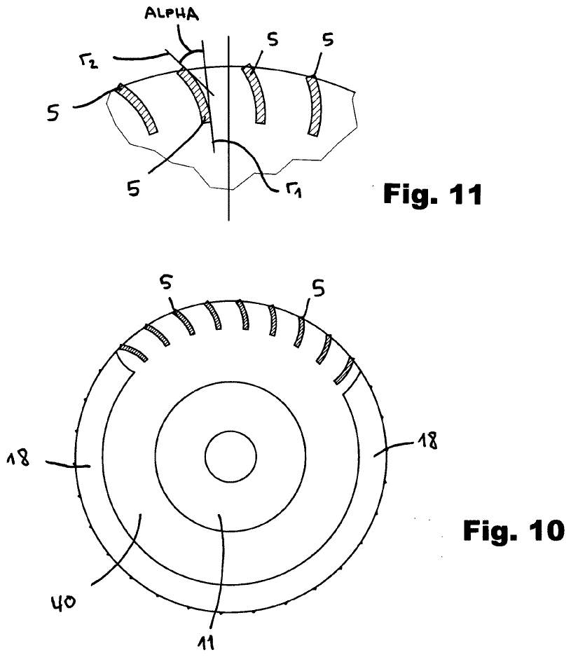

The embodiment of the disk 7 seen in the merely schematic FIGS. 10 and 11 and the blade 4 are distinguished from the preceding embodiment in that the blades 5 are curved. Even if this is not illustrated in the drawing, in any case the radially inner ends of the blades 5 have front-end roundings, as described above in detail in the context of the first embodiment. The density of blades is also consistent with the invention in reality, though this is likewise not depicted in FIGS. 10 and 11.

In general, this variant as well corresponds to the embodiment just discussed in relation to FIGS. 3A and 3B, and thus (except for the blade's curved configuration as such) the prior comments also apply here.

The configuration and positioning of the blades 5 shown in FIG. 11 can best be described in relation to the (imaginary) straight lines r1 and r2. Straight line r1 constitutes a radial of the disk 7 emanating from the rotational axis, forming a tangent to the radially inner end of a blade on its advanced rotating side. Straight line r2 constitutes the tangent to the radially outer end of a blade on its rotationally advancing side.

On the other hand, the two straight lines form the angle, Alpha. The ALPHA angle is approximately 10° to 25°, or better 15° to 20°.

The blades are preferably curved throughout their entire length, consistently.

The advantage of such a configuration of the blades 5 consists, among other things, in the fact that the graphite particles are impacted with a stronger colliding force. This in turn favors the retransport to the work space 40 upon the particles'reaching the impact surface 6.

Even if there is not as yet any demand for it, it should be stated that the sphere sifter claimed here is suited in some cases for folding or rounding of other material particles such as aluminum or other metal-based particles. Thus, it is worth mentioning here that the patent claims can rightfully employ the term “graphite-based particles” interchangeably with the related term “material particles to be folded.”

This comment applies to the entire text even if it is not repeated explicitly.

1. A device for rounding a graphite-based material comprising a work space, in which rounding takes place; an insertion device for introducing the graphite-based material into the work space; a number of rounding tools situated in the work space and configured in the form of blades to move rotationally, positioned on a disk rotating about a rotational axis and in a rotational direction, preferably having at least one guide apparatus and with a separating device to separate fine material and the finest material, having a product outlet and preferably a covering ring, positioned above the rounding tools, distinguished in that the disk bears at least 40, better at least 45, and most preferably at least 55 blades per meter of circumference.

2. The device for rounding graphite-based material, preferably according to claim 1, wherein the radial length of the blades and/or the distance between immediately neighboring blades and/or the height of the blades measured in the direction of the rotation axis is selected in such a way that the majority of collision occurrences between the particles to be rounded and the blades take place on the radially inner first sixth, or better in the area of the inner first ninth of the blades.

3. The device for rounding graphite-based material according to claim 1, wherein the ratio of the blade length measured in the radial direction to the outer radius of the rotatable disk bearing the blades is between 0.1 and 0.25 to 1 and preferably below 0.2 to 1.

4. The device for rounding graphite-based material according to claim 1, wherein the height of the blades from their radially inner end to their radially outer end changes, preferably in such a way that it reaches a height reduction of 10% to 40% from the radially inner end to the radially outer end of a respective blade

5. The device for rounding graphite-based material according to claim 1, wherein the diameter of the classifier wheel effective in the classification is 20% to 50%, and better only 20% to 35%, of the outer diameter of the disk on which the blades rotate.

6. The device for rounding graphite-based material, preferably according to claim 1, wherein it can be stated for the great majority or all of the blades that the proportion of the blade length to the blade width is greater than 5:1 and preferably greater than 10:1.

7. The device for rounding graphite-based material, preferably according to claim 1, wherein the impact surface, which is constituted preferably by an area of the cylindrically configured inner lining surface of the housing, is smooth or rippled without edges.

8. The device for rounding graphite-based material, preferably according to claim 1, wherein the guide apparatus consisting of the guide elements terminates on its inner side flush with the blade upper edge.

9. The device for rounding graphite-based material, preferably according to claim 1, wherein the main impact surfaces of some or all blades on the whole, or at least at their radially outer end, have a tangent, which forms an angle Alpha with the radial.

10. The device for rounding graphite-based material, preferably according to claim 1, wherein the blades consist of plates which are curved outward in an arc-like shape.

11. The device for rounding graphite-based material according to claim 2, wherein the ratio of the blade length measured in the radial direction to the outer radius of the rotatable disk bearing the blades is between 0.1 and 0.25 to 1 and preferably below 0.2 to 1.

12. The device for rounding graphite-based material according to claim 2, wherein the height of the blades from their radially inner end to their radially outer end changes, preferably in such a way that it reaches a height reduction of 10% to 40% from the radially inner end to the radially outer end of a respective blade.

13. The device for rounding graphite-based material according to claim 2, wherein the diameter of the classifier wheel effective in the classification is 20% to 50%, and better only 20% to 35%, of the outer diameter of the disk on which the blades rotate.

14. The device for rounding graphite-based material, preferably according to claim 2, wherein it can be stated for the great majority or all of the blades that the proportion of the blade length to the blade width is greater than 5:1 and preferably greater than 10:1.

15. The device for rounding graphite-based material, preferably according to claim 2, wherein the impact surface, which is constituted preferably by an area of the cylindrically configured inner lining surface of the housing, is smooth or rippled without edges.

16. The device for rounding graphite-based material, preferably according to claim 2, wherein the guide apparatus consisting of the guide elements terminates on its inner side flush with the blade upper edge.

17. The device for rounding graphite-based material, preferably according to claim 2, wherein the main impact surfaces of some or all blades on the whole, or at least at their radially outer end, have a tangent, which forms an angle Alpha with the radial.

18. The device for rounding graphite-based material, preferably according to claim 2, wherein the blades consist of plates which are curved outward in an arc-like shape.

19. The device for rounding graphite-based material, preferably according to claim 3, wherein it can be stated for the great majority or all of the blades that the proportion of the blade length to the blade width is greater than 5:1 and preferably greater than 10:1.
